(19) United States
(12) Patent Application Publication
(10) Pub. No.: US 2025/0328000 A1
(43) Pub. Date: Oct. 23, 2025

(54) Apparatus and method for microscopic illumination of a sample, microscope and microscopy method

(71) Applicant: Carl Zeiss Microscopy GmbH, Jena (DE)

(72) Inventors: Joerg Siebenmorgen, Jena (DE); Richard Hollinger, Jena (DE); Ralf Netz, Jena (DE)

(21) Appl. No.: 19/184,266

(22) Filed: Apr. 21, 2025

(30) Foreign Application Priority Data
Apr. 22, 2024 (DE) 10 2024 111 213.1

(51) Int. Cl. G02B 21/06; G02B 6/12

(52) U.S. Cl. CPC G02B 21/06; G02B 6/12; G02B 2006/12038; G02B 2006/12121; G02B 2006/1215

(57) ABSTRACT

The invention relates to an apparatus for microscopic illumination of a sample, having a laser for transmitting illumination light, having an illumination beam path with a microscope objective for guiding the illumination light into a sample plane on or in the sample, the illumination beam path comprising at least one spatial light modulator for manipulating the illumination light, and having a control unit for controlling at least the spatial light modulator. According to the invention, the apparatus is characterized in that the illumination beam path comprises a phase device for at least partial cancellation of a spatial coherence of the illumination light. The invention also relates to a method for microscopic illumination of a sample, a microscope and a microscopy method.

The current application claims the benefit of German Patent Application No. 10 2024 111 213.1, filed on 22 Apr. 2024, which is hereby incorporated by reference.

In a first aspect, the invention relates to an apparatus for microscopic illumination of a sample, according to the preamble of Claim 1. In a further aspect, the invention relates to a method for microscopic illumination of a sample, according to the preamble of Claim 23. The invention also relates to a microscope and a microscopy method.

A generic apparatus for microscopic illumination of a sample comprises at least the following constituent parts: a laser for transmitting illumination light, an illumination beam path with a microscope objective for guiding the illumination light into a sample plane on or in the sample, the illumination beam path comprising at least one spatial light modulator for manipulating the illumination light, and a control unit for controlling at least the spatial light modulator.

In a generic method for microscopic illumination of a sample, at least the following method steps are performed: illumination light of a laser is guided via an illumination beam path with a microscope objective onto or into the sample and the illumination light is manipulated in the illumination beam path using a spatial light modulator.

An apparatus of the generic type and a method of the generic type are known from EP 3588164 A1, for example.

The generation of any desired illumination pattern in a sample by way of the use of spatial light modulators (SLMs) is known, for example in the context of optical manipulators. A control pattern for a spatial light modulator arranged in a pupil plane that generates a specific desired illumination pattern in the sample may be generated using the Gerchberg-Saxton algorithm (GS algorithm), for example. A disadvantage of the GS algorithm is that random high-frequency bright/dark modulations are created in the illumination pattern. These bright/dark modulations are also referred to as speckles or a speckle pattern. A known option for suppressing these speckles lies in using the GS algorithm to calculate a plurality of control patterns with in each case a random start phase and displaying these different control patterns sequentially in time using the spatial light modulator such that, averaged over time, an illumination is obtained in which the high-frequency bright/dark modulations, which are considered disadvantageous, no longer occur. The control patterns are also referred to as GS phase patterns. Should the GS phase patterns alternate sufficiently quickly during the integration time of a camera, the two-dimensional fluorescence signals of a sample that are linked to the sequential illuminations are integrated and homogenized by the camera. The overall illumination as sum of sequential individual illuminations is more homogeneous than the individual illumination [Son95]. Alternatively, a plurality of images may be recorded using the camera, with a different GS phase illumination pattern being used for each image. The images are subsequently added. These methods are relatively complicated.

To destroy a spatial coherence of a laser, [Lap23] used a multi-retarder glass plate in an optical illumination beam path. The multi-retarder glass plate has different thicknesses. The optical path length difference between different parts of the glass plate is then dimensioned such that the component laser beams are no longer coherent with one another. Ultimately, the component laser beams are imaged onto the same location by means of a microlens array and summed there, albeit incoherently, i.e. in terms of intensity.

Diffusing plates are used in a further option for removing the unwanted bright/dark modulations. Diffusing plates are glass plates with a roughened surface. The unevenness of the surface leads to a small amount of scattering of the transmitted laser light, typically by a few degrees, and impresses a speckle pattern onto the laser light. Should the diffusing plate be rotated or linearly displaced quickly, the speckle pattern changes, in each case in a manner dependent on the position of the diffusing plate. Consequently, this gives rise to a quickly changing speckle pattern. During an exposure time of the camera, the individual spectral patterns are added incoherently in the sample, and a virtually spectacle-free image is obtained [Art20]. This method is also comparatively complicated.

A problem addressed by the invention can be considered that of specifying an apparatus and a method for microscopic illumination of a sample and a microscope and a microscopy method, in which accurate illuminations are made possible with reduced outlay in comparison with the prior art.

This problem is solved by the apparatus having the features of Claim 1 and by the method having the features of Claim 23. Moreover, the microscope having the features of Claim 21 and the microscopy method having the features of Claim 24 are claimed.

Advantageous exemplary embodiments of the apparatus according to the invention and of the microscope according to the invention and advantageous variants of the method according to the invention are explained below, in particular in association with the dependent claims and the figures.

According to the invention, the apparatus of the aforementioned type for microscopic illumination of a sample is developed in that the illumination beam path comprises a phase device for at least partial cancellation of a spatial coherence of the illumination light.

According to the invention, the method of the aforementioned type for microscopic illumination of the sample is developed in that a spatial coherence of the illumination light in the illumination beam path is at least partly cancelled by a phase device.

The microscope according to the invention for examining a sample comprises the following constituent parts: an apparatus according to the invention for microscopic illumination of the sample, at least one detector for detecting detection light emitted by the sample as a consequence of irradiation with excitation light, and a detection beam path with the microscope objective or a further microscope objective for guiding the detection light onto the detector, wherein the control unit is also configured to evaluate measurement data from the detector.

In the microscopy method according to the invention, the following method steps are performed: the sample is illuminated using the method according to the invention for microscopic illumination, and detection light emitted by the sample as a consequence of irradiation with illumination light or as a consequence of irradiation with a different excitation light is guided via a detection beam path with the microscope objective or a further microscope objective onto a detector and detected by the latter.

An essential concept of the invention can be considered that of at least partly destroying the coherence in the illumination beam path using only a single component, the phase device. A further essential concept of the invention can be considered that of decomposing an illumination beam path into at least two component beams, which superimpose incoherently in the sample, by means of the phase device. Each of these component beams is inherently coherent. However, the various component beams are not coherent with one another.

An essential advantage of the invention is that highly accurate illuminations are achieved with simpler means in comparison with the relatively complicated known methods.

The illumination method according to the invention may be performed using the illumination apparatus according to the invention in particular. The illumination apparatus according to the invention may be configured to perform the method according to the invention in particular. The microscopy method according to the invention may be performed using the microscope according to the invention in particular. The microscope according to the invention may be configured to perform the microscopy method according to the invention in particular.

The term illumination should be understood to mean any type of irradiation of the sample with the illumination light. This illumination is microscopic to the extent that the illuminated structure dimensions are of the order of the optical resolving power of the utilized microscope objective. The illumination light is electromagnetic radiation in the visible range and adjoining ranges.

In principle, there are no restrictions as regards the samples to be illuminated and/or examined. There are particularly advantageous use options for the apparatus according to the invention, the microscope according to the invention and the methods according to the invention for biological samples.

The term “illumination beam path” denotes all optical beam-guiding and beam-modifying components, for example a microscope objective, lenses, mirrors, prisms, gratings, filters, stops, beam splitters, modulators, e.g. spatial light modulators (SLM), by means of which and via which illumination light, manipulation light and/or excitation light is guided up to the sample to be illuminated, manipulated and/or examined. Beam-modifying components may also comprise dispersive and in particular diffractive elements. Commercially available microscope objectives can be used, in principle.

In particular, the excitation light may be the illumination light of the apparatus according to the invention for microscopic illumination. However, it is also possible that the excitation light is radiated onto or into the sample from a further light source and optionally via a further illumination beam path.

The term illumination beam is intended to denote the totality of the illumination light propagating along the illumination beam path at a specific time or in a specific structure.

The term pupil plane denotes a plane which is perpendicular, in particular with respect to the optical axis of the illumination beam path or of the detection beam path, and which is optically conjugate to a back focal plane of the respective microscope objective. The term intermediate image plane denotes a plane which is perpendicular, in particular with respect to the optical axis of the illumination beam path or of the detection beam path, and which is optically conjugate to an image plane of the respective microscope objective.

When the present description mentions that a component is situated in a pupil plane or in an intermediate image plane, that is always also taken to mean that the relevant component is situated in the vicinity of the respective pupil plane or in the vicinity of the respective intermediate image plane. That is already inherently clear anyway because neither the pupil planes nor the intermediate image planes are planes in the mathematical sense and because the components under consideration here, for example the spatial light modulators and lenses, each have a finite extent in the direction of the optical axis.

Detection light is electromagnetic radiation emitted by the sample illuminated with the excitation light. Emitting means that the detection light comes from the sample. The detection light can be reflected back from the sample or can be light which is transmitted through the illuminated sample. The detection light can typically be, in comparison with the excitation light, red-shifted fluorescence from fluorescent markers used to prepare the sample.

Commercially available detectors can be used as detectors. Particularly preferably, semiconductor detectors are used. The detector can be in particular a two-dimensionally spatially resolving detector, thus a camera, for example a CCD, CMOS or SPAD array camera. However, for specific microscopy techniques, for example those in which an illumination point or an illumination line is scanned over or through the sample, it is possible to use a punctiform detector, for example a photomultiplier, or a linear/multipixel detector, for example a CCD or CMOS line array or a linear SPAD array.

The term detection beam path denotes all beam-guiding and beam-modifying optical components, for example objectives, lenses, mirrors, prisms, gratings, filters, stops, beam splitters, modulators, for example spatial light modulators (SLM), by means of which and via which the detection light is guided from the sample to be examined to the detector. The microscope objective of the illumination beam path and the microscope objective of the detection beam path can be one and the same microscope objective. That can be the case for reflected-light microscopy, for example, in which the sample is illuminated and observed from one and the same direction. However, the microscope objective of the illumination beam path can also differ from that of the detection beam path. That is the case for example for transmitted-light microscopy and for reflected-light microscopy in which the sample is illuminated and observed obliquely, as in e.g. light sheet microscopy.

The term controller denotes all hardware and software components that interact with the components of the apparatus according to the invention and of the microscope according to the invention, in each case for the intended function thereof. In particular, the controller may comprise a computing device, for example a PC, and a camera controller. The computer resources of the controller may be distributed among a plurality of computers and optionally a computer network, in particular also via the Internet. The controller may have in particular customary operating equipment and peripherals, such as mouse, keyboard, screen, storage media, joystick, Internet connection. The controller may in particular read the data, for example image data, from the detector and may also be configured and serve to control the light source. According to the invention, the controller is at least configured to control the spatial light modulator. If further spatial light modulators are present, the control unit can advantageously also be configured for controlling these further light modulators.

Control patterns for the spatial light modulator, for example in the pupil plane, which allows a desired illumination pattern to be attained in an intermediate image plane and sample plane can be obtained, for example using the Gerchberg-Saxton algorithm. In principle, any desired patterns, including three-dimensional patterns, can be created, although the computational complexity is considerable.

Moreover, the control pattern may be calculated using what are known as superposition algorithms, in which, for the purpose of displaying a plurality of points in two or three dimensions, a hologram in each case consisting of a lateral translation term (blazed grating) and an axial defocus term (Fresnel lens) is created for each of the points. These algorithms have comparatively low computational complexity.

Finally, the control pattern may be calculated using what is known as the phase grating method. In this case, a desired intensity distribution is created by a procedure in which the optical plane of the spatial light modulator in the pupil plane or of the spatial light modulator in the intermediate image plane is areally illuminated and then a phase grating diffracts only the respectively desired intensity distribution over the optical axis. This may be achieved by means of an amplitude modulation of the phase grating. For example, a blazed grating is used as a phase grating.

For the purposes of the present invention, the term phase device denotes an optical component which, at different spatial positions relative to the optical axis, is able to impress different phase shifts on the illumination light in a beam path.

There are many options in view of the specific configuration of the phase device. For example, the phase device may be transparent to the illumination light, at least at some portions of the beam cross section or over the entire beam cross section. Moreover, there is the option of the phase device being reflective to illumination light, at least at some portions of the beam cross section or over the entire beam cross section. Mixed forms are also possible; in this case the phase device is transparent to the illumination light in some portions of the beam cross section and reflective to the illumination light in other portions of the beam cross section.

In principle, it is possible that the phase device comprises a settable phase modulator or is formed by a settable phase modulator. This case would require the phase angle deviations possible by way of the settable phase modulator to be sufficiently large. For example, the settable phase modulator may comprise a pixelated multi-mirror array. The pixelated multi-mirror array may be a CMOS array and/or a DMD (digital mirror device).

In a simple exemplary embodiment of the apparatus according to the invention, the phase device comprises a plane parallel glass plate, the thickness of which is at least as large as a coherence length of the laser and which is introduced into the illumination beam path in such a way that a first component of the illumination light, for example a first half, passes through the glass plate, and a second component, for example the second half, does not pass through the glass plate. Two component beams are created as a result. Since the two patterns in the sample are no longer coherent with one another, they add incoherently.

In a particularly preferred configuration of the apparatus according to the invention, the phase device comprises a glass plate with a plurality of steps or is formed by such a glass plate. In principle, it is preferable for the coherence between the various component beams to be cancelled completely. This would be implemented if the different steps in the glass plate were to differ in terms of their height by 100% or more of a coherence length of the utilized laser. For example, the heights of the various steps of the glass plate may in each case differ by integer multiples of a coherence length of the utilized laser. However, only partial cancellation of the coherence may be sufficient for some applications. In advantageous variants, the different steps in the glass plate might differ in terms of their height by at least 70% and preferably by 85% or more of a coherence length of the utilized laser.

In principle, it is possible that the component beams that are created by the phase device have different beam cross sections at the location of said phase device. However, the component beams preferably each have the same beam cross section at the location of the phase device. For instance, this can be implemented by a stepped glass plate, the step regions of which, through which the illumination beam passes, each having the same cross section. In a preferred exemplary embodiment, the step regions of the glass plate may be circular sectors, in particular circular sectors of equal size, with the optical axis running through the centre of an associated circle.

A further degree of freedom is the location at which the phase device is arranged in the illumination beam path. In principle, it is possible to position the phase device in an intermediate image plane or in the vicinity of an intermediate image plane. However, in preferred embodiments of the apparatus according to the invention, the phase device is arranged in a pupil plane or in the vicinity of a pupil plane.

The beam cross sections belonging to the component beams may be formed by a contiguous area for at least one of the component beams. This was the case for all component beams in each of the exemplary embodiments described up until this point. As a consequence, each of the partial beams in each case uses only a portion of an entire numerical aperture of the microscope objective, and the spatial resolution of the illumination structures that can be created by the component beams in each case is reduced accordingly; this may be considered disadvantageous depending on the application.

In this aspect, it may be advantageous that, for at least one of the component beams, the beam cross sections belonging to the component beams are composed of multiple or many partial cross sections. For example the beam cross sections belonging to the component beams may each be composed of many partial cross sections, and the partial cross sections may be arranged in a manner distributed over an entire beam cross section, in particular randomly, in the spatial domain and/or in the spatial frequency domain. What is achieved by the arrangement distributed over the entire beam cross section is that each of the component beams uses the full aperture of the microscope objective. What is achieved by the arrangement distributed over the spatial frequency domain is that lattice-like structures in the sample are avoided.

In principle, it is possible that the partial cross sections of a specific component beam have different sizes. However, by preference, the partial cross sections of the component beams are chosen to have the same size each case.

Component beams in which an entire beam cross section is composed of multiple or many partial cross sections for at least one component beam or for each of the component beams may for example be implemented by a stepped glass plate that comprises n different step types, with the steps of one step type each having the same step height, wherein the step heights of different step types in each case differ sufficiently in pairwise fashion, for example by integer multiples of a coherence length of the laser, such that a coherent component beam is in each case formed by a totality of the steps of one step type. In order to achieve the case that each of the component beams is able to use the complete aperture of the microscope objective and avoid lattice-like structures in the sample, the steps of each step type may preferably be arranged, in particular randomly, in a manner distributed over the entire beam cross section in the spatial domain and/or in the spatial frequency domain.

The steps of one step type may have different cross sections as a matter of principle. However, they preferably have the same cross section in each case. Furthermore, the steps of different step types may each have different cross sections. However, by preference, the steps of all step types each have the same cross section.

Spatial light modulators (SLM=Spatial Light Modulator) are equipment which can vary a phase and/or an amplitude of incident light in a location-dependent manner in the beam cross section. This can be done individually for each point in the beam cross section. Spatial light modulators can have for example 1920×1080 elements on a chip with a chip diagonal of one to two centimetres. In the case of ferroelectric spatial light modulators, comparatively high repetition rates of several kHz are possible, but they are inefficient with a luminous efficiency of only approximately 5%. In the case of nematic spatial light modulators, although only repetition rates of 60 Hz to 180 Hz are possible, luminous efficiencies of up to 80% can be achieved. In this case, the term luminous efficiency denotes the ratio between the light incident on the respective spatial light modulator and the light shaped by this light modulator.

The spatial light modulator may be arranged in a pupil plane or in the vicinity of a pupil plane of the illumination beam path. However, it is also possible that the spatial light modulator is arranged in an intermediate image plane or in the vicinity of an intermediate image plane of the illumination beam path. The spatial light modulator can be, in principle, the sole spatial light modulator in the illumination beam path. However, it is also possible for the spatial light modulator to be a first spatial light modulator and for a second spatial light modulator to be arranged in the illumination beam path. For example, the first spatial light modulator may be arranged in a pupil plane or in the vicinity of a pupil plane and the second spatial light modulator may be arranged in an intermediate image plane or in the vicinity of an intermediate image plane, or vice versa. In a particularly preferred configuration, the first spatial light modulator can be formed by a first sub-region of a spatial light modulator, and the second spatial light modulator can be formed by a second sub-region of the same spatial light modulator. In principle, it is possible for one, several or all of the components of first spatial light modulator, second spatial light modulator, spatial light modulator to be formed by an amplitude-modulating spatial light modulator. It is advantageous, however, if one, several or all of the components of first spatial light modulator, second spatial light modulator, spatial light modulator is or are formed by a phase-modulating spatial light modulator. Phase-modulating spatial light modulators are preferred in general owing to the smaller light losses. Then, one, several or all of the components of first spatial light modulator, second spatial light modulator, spatial light modulator can be formed by a reflective spatial light modulator. However, it is also possible for one, several or all of the components of first spatial light modulator, second spatial light modulator, spatial light modulator to be formed by a transmissive spatial light modulator. By way of example, one, several or all of the components of first spatial light modulator, second spatial light modulator, spatial light modulator can be formed by one or more of the following components: DMD (Digital Mirror Device), nematic SLM, LCOS display (LCOS=Liquid Crystal on Silicon), variable phase plate, controllable deformable mirror (DM).

In a particularly preferred configuration of the apparatus according to the invention, a scanner is present for varying a region in the sample that is irradiated by illumination light. By preference, the scanner is arranged in a pupil plane of the illumination beam path or in the vicinity of a pupil plane of the illumination beam path. For example, the scanner may be a galvanometric scanner or MEMS scanner. The control unit may advantageously be configured to control the scanner.

In a further advantageous exemplary embodiment, the control unit is configured to control the spatial light modulator and/or the scanner to generate a light sheet.

For example, the control unit may be configured to control the spatial light modulator and the scanner for what is known as lattice light sheet illumination. In the process, two sinc\hat{ }3 beams that propagate at an angle to one another are created. The two beams superimpose in the sample and interfere with one another. This leads to the lattice structure of the lattice light sheet. Since the lattice structure generally disturbs fluorescence imaging, the light sheet is quickly displaced by the scanner in order to blur out the lattice structure. In an alternative to the sinc\hat{ }3 beams or in addition, it is also possible to use coherent Bessel or lattice light sheets [US 2013/0286181 A1].

Particularly advantageous applications of the apparatus according to the invention are possible if the apparatus is designed as an optical manipulator for microscopic optical manipulation of a sample. The term optical manipulation should be understood to mean any permanent or only temporary physical change to a sample that can be brought about by irradiating the sample with illumination light, which may also be referred to as manipulation light in this case. This optical manipulation is microscopic to the extent that it is possible to perform spatially structured manipulations with structure dimensions that are of the order of the optical resolving power of the utilized microscope objective or even below this for some microscopy methods.

In the case of an apparatus according to the invention designed as an optical manipulator, the spatial light modulator is preferably arranged in a pupil plane.

An example of an optical manipulation that may typically be performed using the apparatus according to the invention and the method according to the invention is that of exciting dye molecules, used to prepare a sample, into fluorescing states. Thereupon, fluorescence emitted by the sample may be observed using the microscope according to the invention. Further examples of optical manipulations include bleaching of fluorescent dyes, quenching of fluorescent dyes and releasing of particles in the sample (uncaging).

In a further advantageous configuration of the apparatus according to the invention, the control unit is configured to control the spatial light modulator to generate an illumination pattern for TIRF microscopy (TIRF microscopy=total-internal reflection fluorescence microscopy). In that case, the spatial light modulator may advantageously be arranged in an intermediate image plane of the illumination beam path.

In the TIRF illumination mode, at least one laser point is generated at the edge of the pupil. As a result, the laser illumination propagates in the direction of the objective focus at such a large angle with respect to the optical axis in the object domain that there is total-internal reflection of the laser light at the transition, a glass/water interface as a rule, from the coverslip to the sample. Inhomogeneities may arise in the illumination as a result of the propagation of the illumination light in the edge region of the objective. A development of TIRF consists of what is known as ring TIRF: The laser point is placed at different locations on the edge of the pupil sequentially in time. Consequently, it is possible to set the direction from which the beam is incident on the glass/water interface. If the laser point alternates quickly in the pupil during the integration time of the camera, the sequential 2-D fluorescent images (2-D=two-dimensional), created by the sequential illuminations, are added or integrated by the camera and thus exhibit an overall fluorescence image with a homogeneous illumination in accordance with the more homogeneous overall illumination [Liu20].

The control unit may be configured to control the spatial light unit to generate illumination patterns for the sample manipulation. In an alternative to that or in addition, the control unit may be configured to control the spatial light modulator to generate illumination patterns for structured illumination microscopy (SI microscopy; SIM=structured illumination microscopy). Sample manipulation and microscopy may also be performed together, sequentially or else simultaneously. The control unit may be configured to control the spatial light modulator to generate illumination patterns for structured illumination microscopy (SI microscopy; SIM=structured illumination microscopy). In that case, the spatial light modulator may again be advantageously arranged in an intermediate image plane of the illumination beam path. In SI microscopy, the spatial light modulator is used to display phase patterns in the form of one-dimensional (1D) or two-dimensional (2-D) point gratings. The phase pattern of a 1 D line grating may consist of periodically alternating regions on the second spatial light modulator with a phase angle deviation of 0 or π. The phase pattern of a 2D point grating can be a chequerboard pattern in which the fields alternately have a phase angle deviation of 0 or π. The two phase patterns generate in the objective pupil orders of diffraction which correspond to a 1D SIM light grating or 2D SIM point grating in the object domain. If the phase patterns are represented in a manner temporally sequentially shifted on the spatial light modulator, then there is also a shift in the SIM gratings in the sample and images with shifted gratings can be recorded and subsequently computed. SIM methods are also possible with incidence of the excitation light in such a way that the TIRF condition is satisfied. Such methods are also referred to as TIRF-SIM methods.

Further advantages and features of the present invention are explained below in association with the figures, in which:

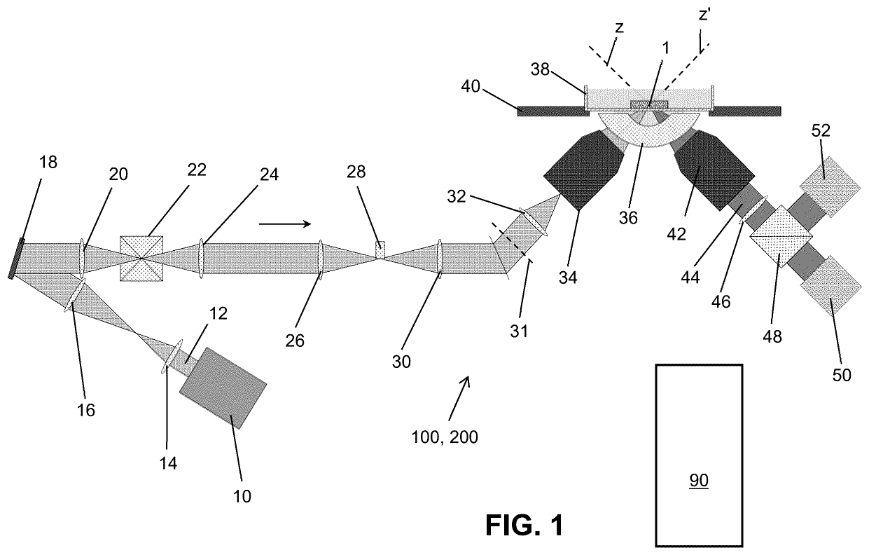

FIG. 1 shows a schematic illustration of a first exemplary embodiment of an apparatus according to the invention and a microscope according to the invention;

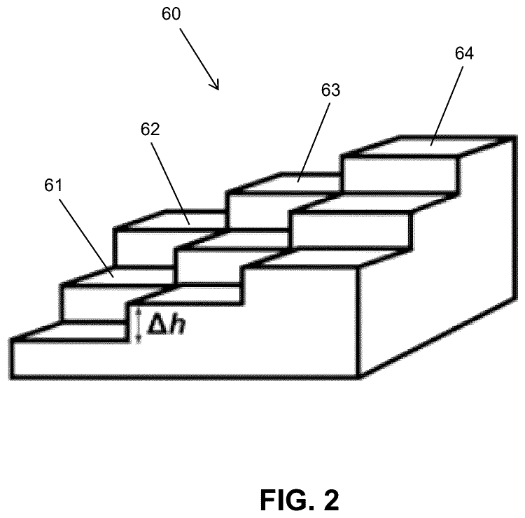

FIG. 2 shows a schematic illustration of a first example of a stepped glass plate for use in an apparatus according to the invention;

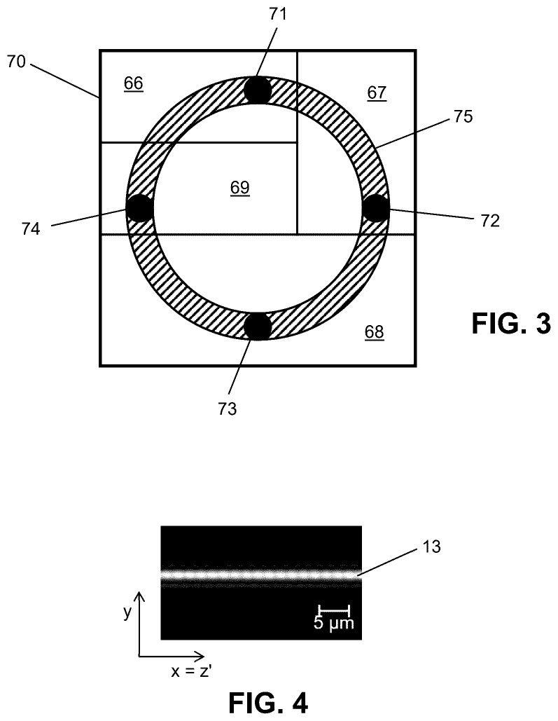

FIG. 3 shows a schematic illustration of a second example of a stepped glass plate for use in an apparatus according to the invention;

FIG. 4 shows a schematic illustration of an intensity distribution of a light sheet;

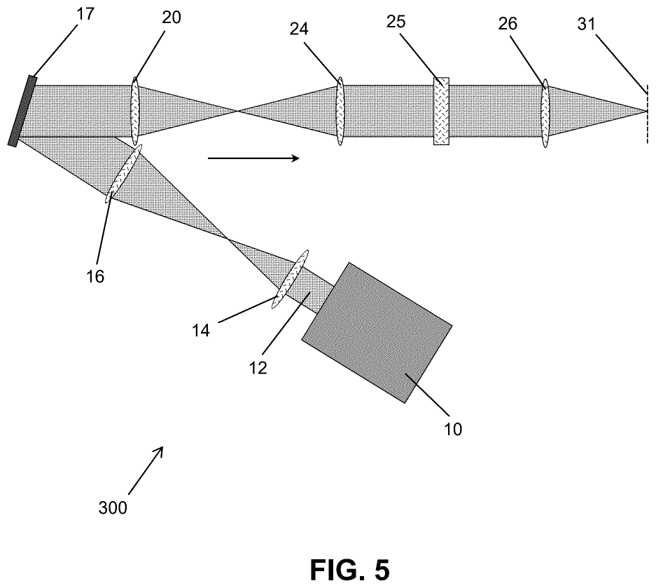

FIG. 5 shows a schematic illustration of a partial view of a second exemplary embodiment of an apparatus according to the invention;

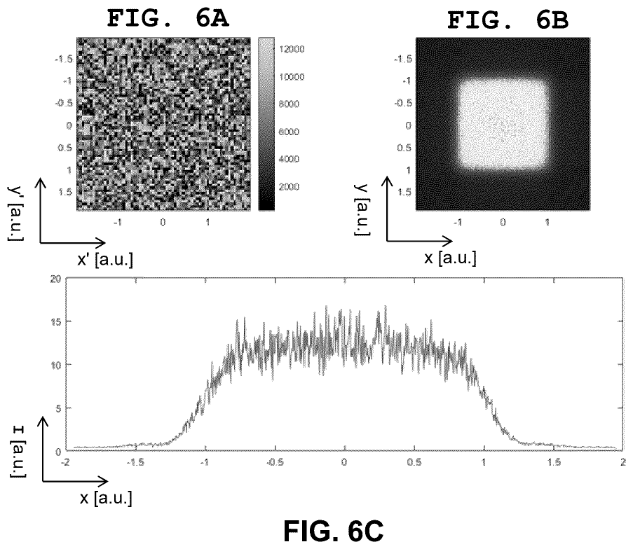

FIG. 6A shows an arrangement and height of the steps in a third example of a stepped glass plate for use in an apparatus according to the invention, FIG. 6B shows, as a heat map, an intensity distribution in the sample plane obtained using the stepped glass plate from FIG. 6A, FIG. 6C shows an intensity obtained by the stepped glass plate from a) in the sample plane, plotted against lateral coordinate x.

A first exemplary embodiment of an apparatus 100 according to the invention and of the microscope 200 according to the invention are explained with reference to FIG. 1. According to the invention, the apparatus 100 for microscopic illumination of a sample 1 comprises a laser 10 for transmitting illumination light 12 and an illumination beam path having a microscope objective 34 and serving to guide the illumination light 12 into a sample plane on or in the sample 1. According to the invention, the illumination beam path for manipulating the illumination light 12 comprises a spatial light modulator 18 which, in the exemplary embodiment shown in FIG. 1, is arranged in an intermediate image plane, i.e. in a plane that is optically conjugate to the illuminated plane in the sample 1. A further intermediate image plane is identified by reference sign 31. Moreover, a control unit 90, which may be a PC for example, is present for controlling at least the spatial light modulator 18.

According to the invention, a phase device 28 is thereupon present in the illumination beam path and serves to at least partially cancel a spatial coherence of the illumination light 12.

In the exemplary embodiment shown in FIG. 1, the phase device is a glass plate 28 that is transparent to the illumination light 12. The glass plate 28 is arranged in a pupil plane of the illumination beam path such that half of the beam cross section passes through the glass plate 28 and the other half remains uninfluenced by the glass plate 28.

Initially, a part of the microscope 200 according to the invention for examining the sample 1 is the apparatus 100 for microscopic illumination of the sample 1. According to the invention, the microscope 200 moreover comprises at least one detector 50 for detecting detection light 44 emitted by the sample 1 as a consequence of irradiation with excitation light. In this case, the excitation light is the illumination light 12 of the apparatus 100. According to the invention, a detection beam path with a further microscope objective 42 is present for guiding the detection light 44 onto the detector 50. The control unit 90 is also configured to evaluate measurement data from the detector 50. Alternatively, it would also be possible for the detection beam path to extend through the microscope objective 34 of the illumination beam path. The detection light 44 emitted by the sample 1 typically is fluorescence from fluorescent dyes that were used to prepare the sample 1 and that are excited by the illumination light 12. For this purpose, the illumination light 12 may also contain different wavelengths.

Using the laser 10 as a starting point, the illumination beam path comprises the following as further components: a collimation lens 14 that collimates the illumination light 12 coming from the laser 10, a lens 16, a lens 20, an xy-scanner 22, a lens 24, a lens 26, a lens 30, a tube lens 32 and a meniscus lens 36. The xy-scanner 22 serves to vary a region in the sample 1 that is irradiated by illumination light 12. It is arranged in a pupil plane of the illumination beam path and may be a galvanometric scanner, for example.

Together with the lens 30, the tube lens 32 forms a relay optics unit that images the back focal plane of the microscope objective 34 into the plane in which the glass plate 28 is arranged. The lenses 24 and 26 implement a further relay optics unit which image the pupil plane in which the glass plate 28 is arranged into a further pupil plane in which the xy-scanner 22 is arranged. Moreover, the lenses 26 and 30 on the one hand and the lenses 20 and 24 on the other hand each act as a relay system and together image the intermediate image plane 31 into the plane in which the spatial light modulator 18 is arranged. In the example shown, the spatial light modulator is a reflective light modulator which can preferably be a phase-modulating light modulator, for example an LCoS display (LCoS=liquid crystal on silicon).

The sample 1, which may be a biological sample for example, is situated in a sample container 38 in the situation shown in FIG. 1, for example in a petri dish that is held by a sample stage 40. The sample stage 40 can typically be manipulated in all three spatial directions.

An optical axis of the microscope objective 34 is provided with reference sign z′, and an optical axis z of the microscope objective 42 of the detection beam path is provided with reference sign z. In the structure shown in FIG. 1, the control unit 90 is configured for a suitable control of the spatial light modulator 18 and optionally of the scanner 22, in such a way that a lattice light sheet is generated in the sample 1. In the exemplary embodiment shown, the optical axes z′ and z of the microscope objectives 34 and 42 extend perpendicular to one another, i.e. the microscope objective 42 perpendicularly views the light sheet in the sample 1 that was created by the spatial light modulator 18 and optionally the scanner 22.

As further components, the detection beam path contains a tube lens 46 and a colour splitter 48 that serves to guide fluorescence with a first colour onto the first detector 50 and fluorescence with a second colour that differs from the first colour onto a second detector 52.

The control unit 90 may also be configured to control the first detector 50 and the second detector 52 and evaluate the measurement data thereof. The control unit 90 is suitably operatively connected to those components that it is configured to control and whose measurement data or other data it evaluates, the connection typically being brought about by cables that are not depicted in FIG. 1.

In the exemplary embodiment shown in FIG. 1, the glass plate 28 has a thickness h that approximately corresponds to the coherence length h of the laser 10, for example of the order of 160 μm to 240 μm. The fact that this thickness is advantageous is evident from the following: The bandwidth AA of typical diode lasers as used in fluorescence microscopy is approximately 2 nm to 3 nm. With

$$h = {λ}^{2} / ( Δλ ( n - 1 ) )$$

a coherence length h of approximately 160 μm to 240 μm arises at a wavelength A of 488 nm with the refractive index n=1.5 for glass.

Since the glass plate 28 of thickness h has been introduced into the illumination beam path such that only half of the laser beam traverses the glass plate 28, the two halves of the illumination beam downstream of the glass plate 28, and consequently the two component beams, are inherently spatially coherent in each case, but not spatially coherent relative to one another. Hence, the two component beams are no longer able to interfere with one another but are incoherently added, for example after focusing by the lenses 30 and 32.

In the case of an illumination with a sinc\hat{ }3 light sheet (lattice light sheet), the illumination in a pupil plane consists of—in a simplified representation—two lines, a line on the left half of the pupil plane and a line on the right half of the pupil plane. Each of the line creates a sinc\hat{ }3 light sheet in the sample. Interference in the sample 1 can be prevented by virtue of the glass plate 28 with a thickness of 240 μm covering half of the pupil and hence one of the lines. On account of the incoherent addition, the resultant light sheet has no lattice structure, or in any case a less pronounced lattice structure. It is possibly no longer necessary to scan the light sheet for the purpose of blurring out the lattice structure. Such sample illumination can be used to perform the FLIM method (fluorescence lifetime imaging microscopy), for which a static and consequently non-scanned light sheet without lattice structure is required.

FIG. 4 shows a measured incoherent light sheet 13, which is formed by incoherent superposition of two sinc\hat{ }3 light sheets. The evident remaining minor residual modulation arises due to partial coherence because the glass plate used was only 170 μm thick. The method presented here may also be applied to so-called coherent vessel and lattice light sheets.

Instead of using only a single glass plate 28, it is also possible to use a stepped glass plate 60 of the type schematically shown in FIG. 2. The different steps 61, 62, 63, 64 of the glass plate 60 may differ in their height, for example by integer multiples of a coherence length of the utilized laser, e.g. by integer multiples of 240 μm in each case.

The stepped glass plate 70, which is depicted schematically in FIG. 3 and suitable for TIRF illuminations, may likewise be used in the apparatus of FIG. 1 rather than the glass plate 28. FIG. 3 schematically shows a stepped glass plate 70 with steps 66, 67, 68, 69. An annular region 75, which represents the TIRF region in a pupil plane, is also depicted schematically. The region 75 is distinguished in that beams incident in this annular region are incident on the sample 1 at an angle that is greater than or equal to the angle of total-internal reflection.

The first step 66 has any desired thickness d1, the second step has a thickness of d1+240 μm, the third step 68 has a thickness of d1+2*240 μm and the fourth step 69 has a thickness of d1+3*240 μm.

In a first example, two points, for example the points 72 and 74 or the points 71 and 73, are created simultaneously at the edge of the pupil on opposite sides. Without the stepped glass plate 70, these two points would interfere in the sample 1 and create a stripe pattern. However, if the glass plate 70 with the above-described properties is situated in the beam path, the path difference introduced means that the two component beams are no longer spatially coherent with one another and consequently can no longer interfere in the sample 1. Inhomogeneities in the illumination from one side can thus be corrected by the illumination from the opposite side, without a lattice structure being created in the process.

In the second example, this principle may be extended to a simultaneous four-side TIRF, in which four points 71, 72, 73, 74 are created at the edge of the pupil at the azimuth angles 0°, 90°, 180° and 270° by means of a 2-D grating. Because all four component beams are no longer coherent with one another in pairwise fashion, the incoherent superposition of the four illumination light beams in the sample yields a very uniform illumination.

Applications of the principle according to the invention in an optical manipulator are explained in the context of FIG. 5. The apparatus according to the invention, shown there in part, is designed as an optical manipulator. For example, using the GS algorithm with a spatial light modulator in a pupil plane, a pattern can be generated in that case and imaged into a pupil plane of the illumination beam path.

From the arrangement in FIG. 1, the structure in FIG. 5 differs in that the spatial light modulator 17, present according to the invention, is situated in a pupil plane and in that the lens 30 is not present. The tube lens 32, which is not shown in FIG. 5, and the lens 26 form a relay system which images the back focal plane of the microscope objective 34 into the plane in which the phase device 25 is arranged. Moreover, the lenses 24 and 20 form a relay system which images the plane in which the phase device 25 is situated into the plane in which the spatial light modulator 17 is arranged. The spatial light modulator 17 may once again be a phase-modulating light modulator, for example an LCoS display (LCoS=liquid crystal on silicon).

In FIG. 5, the phase device is realized by a stepped glass plate 25 with four quadrants, for example circular sectors, of equal size. The steps in this glass plate 25, which are not shown in FIG. 5, may once again be formed like in the glass plate 70 of FIG. 3. Hence four component beams are created, each of which create the desired illumination pattern with a different speckle pattern in each case. That is to say, averaging is performed over four different speckle patterns in this case. The image therefore appears more homogeneous.

Alternatively, as described in the context of FIG. 1, half of the pupil plane may also be provided in FIG. 5 with a glass plate 28 with a thickness of 240 micrometres as a phase device according to the invention. This would once again have as a consequence that two component beams are created, each of which creates the desired illumination pattern in the sample 1 on account of the holographic principle, albeit with a different speckle pattern in each case. Since the two speckle patterns are no longer coherent with one another on account of the effect of the glass plate 28, they add incoherently. This would correspond to averaging of two patterns with different speckle patterns and would likewise lead to a reduction in the speckle contrast.

The examples described up until this point are disadvantageous in that the division of the sample reduces the resolution or a maximum possible edge steepness in the desired illumination pattern in the sample. For example, what follows from this is that it is for example not practical to scale the method to for example 64 contiguous, disjoint zones in order to be able to obtain averaging over 64 illumination patterns in the sample.

This can be remedied using the example that is now explained in the context of FIGS. 6A-6C. A stepped glass plate with a complicated shape is used there in order to circumvent the problem of loss of resolution and at the same time create 64 mutually incoherent illumination patterns.

FIG. 6A schematically shows the stepped glass plate that is formed in the manner described, with the height of the steps being elucidated using different shades of grey. FIG. 6B shows an illumination pattern generated in a sample using the glass plate from FIG. 6A, and FIG. 6C shows an intensity profile of the illumination pattern approximately in the region of y=0.

The glass plate elucidated schematically in FIG. 6A has 64 different types of steps. The steps of each step type are in each case formed by cuboid elements. There are five examples of each step type, and each of these examples has the same step height. Different step types in each case have different step heights. The step heights in each case differ by integer multiples of 240 μm. The elements of one type are randomly distributed on the glass plate and moreover distributed in such a way that they cover high and low spatial frequencies. The random distribution prevents lattice-like structures in the sample. Hence, only the partial beams of the illumination light that pass through steps of one and the same step type are coherent with one another. The partial beams of the illumination light that path through steps of different step types are not coherent with one another. That is to say, only partial beams of the illumination light that have passed through the steps of one and the same step type can be spatially structured in independent fashion. Since the steps of each step type are distributed over the entire cross section of the optical system, high and low illumination frequencies can be covered, and consequently the illumination patterns created in the sample may be structured in accordance with the maximum possible spatial resolution of the optical system. Hence, high optical resolution illumination patterns are possible. The illumination patterns of different step types add incoherently, corresponding to an averaging of 64 illumination patterns.

It is clear that the thickness of a stepped glass plate increases proportionally with the number of steps if the heights of the steps are for example required in each case to differ by integer multiples of the coherence length.

Consideration may in that case be given to taking a glass plate with steps of in each case half the height and attaching it in front of a mirror such that each of the steps is traversed twice in the illumination beam path, and hence the same phase retardation is achieved.

### LIST OF REFERENCE SIGNS

1 Sample
10 Light source, laser
12 Excitation light
13 Light sheet in xy-plane of detection beam path
14 Lens
16 Lens
17 Spatial light modulator in pupil plane
18 Spatial light modulator in intermediate image plane
22 Scanner
24 Lens
25 Stepped glass plate in pupil plane
26 Lens
28 Glass plate in pupil plane
30 Lens
31 Intermediate image plane
32 Tube lens in the illumination beam path
34 Microscope objective in the illumination beam path
36 Meniscus lens
38 Sample container, petri dish
40 Sample holder, sample stage
42 Microscope objective in the detection beam path
44 Light emitted from sample 1 as a result of irradiation with excitation light, e.g. illumination light 12
46 Tube lens in the detection beam path
48 Colour splitter
50 First detector, first camera
52 Second detector, second camera
60 Step body, step plate, stepped glass plate
61 Step of step body 60
62 Step of step body 60
63 Step of step body 60
64 Step of step body 60
66 Step of step body 70
67 Step of step body 70
68 Step of step body 70
69 Step of step body 70
70 Step body, step plate, stepped glass plate
71 Illumination point in pupil plane
72 Illumination point in pupil plane
73 Illumination point in pupil plane
74 Illumination point in pupil plane
75 Ring in pupil plane, TIRF region
90 Control unit (PC)
100 Apparatus according to the invention
200 Microscope according to the invention
300 Part of an apparatus according to the invention
z Optical axis of microscope objective 42
z′ Optical axis of microscope objective 34
Δh Height of steps 61-64

### REFERENCES

[Art20] Arias A. et al.: Wavefront-shaping-based correction of optically simulated cataracts; In Optica vol. 7, page 2334 (2020); https://doi.org/10.1364/OPTICA.7.000022
[Lap23]“Speckle- and interference fringes-free illumination system with a multi-retarder plate”, Opt. Expr. 31/12, 19173, 2023
[Liu20] Liu W. et al.: Quantitative objective-based ring TIRFM system calibration through back focal plane imaging; In Opt. Lett. 45, page 3001 (2020)
[Son95] Amako J. et al.: Speckle-noise reduction on kinoform reconstruction using a phase-only spatial light modulator; In Appl. Opt. 34, page 3165 (1995)

1. Apparatus for microscopic illumination of a sample, the apparatus comprising:
a laser for transmitting illumination light,
an illumination beam path with a microscope objective for guiding the illumination light into a sample plane on or in the sample, the illumination beam path comprising at least one spatial light modulator for manipulating the illumination light, and
a control unit for controlling at least the spatial light modulator,
wherein the illumination beam path comprises a phase device for at least partial cancellation of a spatial coherence of the illumination light.

2. Apparatus according to claim 1,
wherein an illumination beam is decomposed into at least two coherent component beams, which superimpose incoherently in the sample using the phase device.

3. Apparatus according to claim 1,
wherein the component beams each have the same beam cross section at the location of the phase device.

4. Apparatus according to claim 1,
wherein the phase device is transparent to the illumination light.

5. Apparatus according to claim 1,
wherein the phase device comprises a plane parallel glass plate, the thickness of which is at least as large as a coherence length of the laser and which is introduced into the illumination beam path in such a way that a first component of the illumination light passes through the glass plate, and a second component does not pass through the glass plate.

6. Apparatus according to claim 1,
wherein the phase device is a glass plate with a plurality of steps.

7. Apparatus according to claim 6,
wherein the heights of the various steps in each case differ by integer multiples of a coherence length of the utilized laser.

8. Apparatus according to claim 6,
wherein the step regions of the glass plate, through which the illumination beam passes, each have the same cross section.

9. Apparatus according to claim 6,
wherein the step regions of the glass plate are circular sectors with the optical axis running through the centre of an associated circle.

10. Apparatus according to claim 1,
wherein the phase device is arranged in a pupil plane of the illumination beam path.

11. Apparatus according to claim 2,
wherein, for at least one of the component beams, the beam cross sections belonging to the component beams are composed of multiple or many partial cross sections.

12. Apparatus according to claim 2,
wherein the beam cross sections belonging to the component beams each are composed of many partial cross sections, and wherein the partial cross sections are arranged in a manner distributed over an entire beam cross section in the spatial domain and/or in the spatial frequency domain.

13. Apparatus according to claim 6,
wherein the glass plate comprises n different step types, with the steps of one step type each having the same step height,
wherein the step heights of different step types in each case differ sufficiently in pairwise fashion, such that a coherent component beam is in each case formed by a totality of the steps of one step type.

14. Apparatus according to claim 13,
wherein the steps of each step type are arranged in a manner distributed over an entire beam cross section in the spatial domain and/or in the spatial frequency domain.

15. Apparatus according to claim 1,
wherein the spatial light modulator is a phase-manipulating spatial light modulator.

16. Apparatus according to claim 1,
wherein the spatial light modulator is arranged in or in the vicinity of a pupil plane and/or an intermediate image plane, of the illumination beam path.

17. (canceled)

18. Apparatus according to claim 1,
further comprising a scanner for varying a region in the sample that is irradiated by illumination light.

19. Apparatus according to claim 1,
wherein the apparatus is designed as an optical manipulator for microscopic optical manipulation of a sample.

20. Microscope for examining a sample, the microscope comprising:
an apparatus for microscopic illumination of the sample according to claim 1,
at least one detector for detecting detection light emitted by the sample as a consequence of irradiation with excitation light,
a detection beam path with the microscope objective or a further microscope objective for guiding the detection light onto the detector,
wherein the control unit is also configured to evaluate measurement data from the detector.

21. Microscope according to claim 20,
wherein the control unit is configured to control the spatial light modulator to generate an illumination pattern for TIRF microscopy and/or illumination patterns for sample manipulation and/or generate illumination patterns for SI microscopy.

22. (canceled)

23. Method for microscopic illumination of a sample, the method comprising:
guiding illumination light of a laser via an illumination beam path with a microscope objective onto or into the sample, the illumination light being manipulated in the illumination beam path using a spatial light modulator,
wherein a spatial coherence of the illumination light in the illumination beam path is at least partly cancelled by a phase device.

24. Microscopy method, the method comprising:
illuminating the sample using the method according to claim 23,
guiding detection light emitted by the sample as a consequence of irradiation with illumination light or as a consequence of irradiation with a different excitation light via a detection beam path with the microscope objective or a further microscope objective onto a detector, and
detecting the detection light by the detector.
